(19) United States
(12) Patent Application Publication
(10) Pub. No.: US 2019/0292844 A1
(43) Pub. Date: Sep. 26, 2019

(54) Protective barrier for an open window

(71) Applicant: Ann Steele, Little Elm, TX (US)

(72) Inventor: Ann Steele, Little Elm, TX (US)

(21) Appl. No.: 15/927,418

(22) Filed: Mar. 21, 2018

(51) Int. Cl. E06B 9/01

(52) U.S. Cl. CPC E06B 9/01; E06B 2009/002

(57) ABSTRACT

The invention is directed to a protective barrier for an open window. The barrier is comprised of a plurality of thin, flexible filaments drawn taut between two posts, which are secured to the window frame. The filaments may be comprised of monofilament fishing line or some other strong, flexible material that is corrosion resistant. The purpose of the barrier is to protect objects placed on the window sill from being knocked off by a gust of wind, or by a passing person or animal. In a second embodiment, additional filaments are provided in a diagonal crisscross pattern to protect smaller objects.

### CROSS-REFERENCE TO RELATED APPLICATIONS

This application relates back to, and claims the priority of Provisional Patent Application No. 62/482,676 filed on Apr. 6, 2017.

### STATEMENT REGARDING FEDERALLY SPONSORED RESEARCH OR DEVELOPMENT

Not Applicable

### PARTIES TO A JOINT RESEARCH AGREEMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

The invention relates generally to household accessories, and in particular to a protective barrier for an open window. For most households, opening the windows from time to time is essential to allow fresh air and sunlight into the home. Items are frequently placed on the window sill temporarily, such as a freshly baked loaf of bread to allow it to cool. Unfortunately, a strong gust of wind can knock over such items, and they may also be knocked over by a pet or a human, particularly a curious child.

A search of the prior art reveals various devices which have been developed to provide the features of a safety barrier for an open window, which is capable of being removed and stored quickly and easily. None are closely related to the present invention, but several include features which resemble those of the present invention. Each has proven to be less than satisfactory for the present purpose in its own way.

Window security apparatus, U.S. Pat. No. 4,059,413 (priority Jun. 4, 1976) provides a security apparatus for attachment to the interior side of conventional residential window structure which includes a horizontal bar, having a plurality of vertical bars fixedly attached thereto. The vertical bars are slidably received in respective apertures suitably provided in the sill of the window, thus the bars may be slidably moved upwardly to a security position which occludes the window and downwardly to an escape position which unobstructs the window. Lock structure is included to lock the bars in the security position and a lock trip/release device makes provisions for releasing the lock structure, which causes the bars to gravitate downwardly to the escape position, thus enabling occupants of the building to escape outwardly through the window in the event of fire and the like.

Apparatus for edge mounting security window film in a window frame, U.S. Pat. No. 5,992,107 (priority Jun. 19, 1997), provides an elongate tensile loading transfer member having first and second adjacent elongate load bearing flanges and corresponding first and second respective elongate bearing surfaces thereon, first and second elongate double sided foam adhesive tape strips mountable, on first sides of the adhesive tape strips, along respective the first and second bearing surfaces, the first adhesive tape strip mountable on its second side, opposite to the first side, to an edge of a sheet of security window film having a thickness of at least 10 mil adhered to a glass window pane, the second adhesive tape strip mountable on its second side, opposite to the first side, to an edge of a window frame adjacent the edge of sheet of security window film, wherein, the first and second adhesive tape strips are adapted to bear approximately 225 lbs per square inch in tension applied to the first and second adhesive tape strips and to the security window film when adhesively mounted to the tensile load transfer member by the first adhesive tape strip and to the window frame when mounted to the tensile load transfer member by the second adhesive tape strip.

Rolling screen, U.S. Pat. No. 6,059,007 (priority Apr. 11, 1996), provides a rolling screen comprised of a screen case, a take-up shaft arranged rotatably about a central axis thereof within the screen case, and a screen wound on said take-up shaft so that the screen can be wound out of said screen case. The take-up shaft is normally biased in a screen-winding direction by a torsion spring. An outer peripheral surface of the screen wound on the take-up shaft is always maintained in contact with an inner wall of the screen case, said inner wall being located in a direction of winding-out of the screen, by pulling force applied to the screen upon extension of the screen or resilient force of a pressing spring when the screen is wound out or wound in.

Foldable device and method for protecting double-hung windows, U.S. Pat. No. 6,161,605 (priority Dec. 14, 1998), provides a foldable, reusable security device and method for protecting double-hung windows from storm debris hazards and vandalism, wherein the perimeter edges of the device fit within the outermost groove of a double-hung window frame and can be easily installed and removed by one adult of ordinary strength and coordination standing behind the window. The device also protects the building against unauthorized entry and burglary, and is particularly useful for protecting upstairs windows since it requires no pre-installation steps or hardware, no professional installation, no tools, no ladder, and its installation does not permanently alter or damage the window or adjacent building surfaces. The device has at least two protective panels with two or more hinges attached between the front surfaces of adjacent panels which allow them to fold substantially parallel to one another in a compact configuration for storage, and unfold again into an essentially planar configuration for use. Straps are attached to the back surfaces of the two endmost panels, drawn around the window sashes and secured by them against the outer window frame, and then pulled taut behind the closed and locked sashes with a quick-release fastener.

Window covering, U.S. Pat. No. 2,865,446 (priority Aug. 11, 1955), provides a window-covering comprising an essentially rectangular piece of fabric doubled back upon itself, with opposing halves of one face of the fabric thus juxtaposed to one another, and a plurality of intervening pleated elements whose opposite ends join, and thereby space apart, opposing portions of the fabric face. The invention contemplates movable supporting of the free ends of the fabric whereby the opposite ends of each of the pleated elements are relatively movable and the pleats correspondingly extensible. In particular, the invention comprehends a curtain adjustable for variable transmission of light or air and comprising two essentially rectangular pieces of net fabric juxtaposed face to face and connected to one another by a plurality of essentially parallel resilient strips, each strip being pleated and being fastened at opposite ends to opposing faces of the net pieces, which are located for limited lengthwise movement with respect to one another so that when they are aligned lengthwise the ends of each strip are directly opposite one another with the pleating essentially closed and when they are misaligned lengthwise the ends of each strip also are misaligned and the pleating extended accordingly.

A simple and inexpensive barrier to prevent objects from falling off the window sill and out the window, while allowing fresh air in through the open window, would be well received. A protective barrier for an open window, which provides flexible filaments across the opening to prevent falling objects, would resolve this problem.

### SUMMARY OF THE INVENTION

Accordingly, the invention is directed to a protective barrier for an open window. The barrier is comprised of a plurality of thin, flexible filaments drawn taut between two posts, which are secured to the window frame. The filaments may be comprised of monofilament fishing line or some other strong, flexible material that is corrosion resistant. The purpose of the barrier is to protect objects placed on the window sill from being knocked off by a gust of wind, or by a passing person or animal. In a second embodiment, additional filaments are provided in a diagonal crisscross pattern to protect smaller objects.

Additional features and advantages of the invention will be set forth in the description which follows, and will be apparent from the description, or may be learned by practice of the invention. The foregoing general description and the following detailed description are exemplary and explanatory and are intended to provide further explanation of the invention.

### BRIEF DESCRIPTION OF THE DRAWINGS

The accompanying drawings are included to provide a further understanding of the invention and are incorporated into and constitute a part of the specification. They illustrate two embodiments of the invention and together with the description, serve to explain the principles of the invention.

FIG. 1 is a front view of the first exemplary embodiment, displaying the barrier 10, the filaments 11, the posts 12, and the brackets 13.

FIG. 2 is a front view of the second exemplary embodiment, displaying the barrier 10, the filaments 11, the posts 12, and the brackets 13.

FIG. 3 is a front view of the first exemplary embodiment inserted into the brackets, displaying the barrier 10, the filaments 11, and the brackets 13.

FIG. 4 is a front view of the second exemplary embodiment inserted into the brackets, displaying the barrier 10, the filaments 11, and the brackets 13.

FIG. 5 is a front perspective view of the second exemplary embodiment, displaying the barrier 10, the filaments 11, the posts 12, and the brackets 13.

FIG. 6 is a front perspective view of the first exemplary embodiment, displaying the barrier 10, the filaments 11, the posts 12, and the brackets 13.

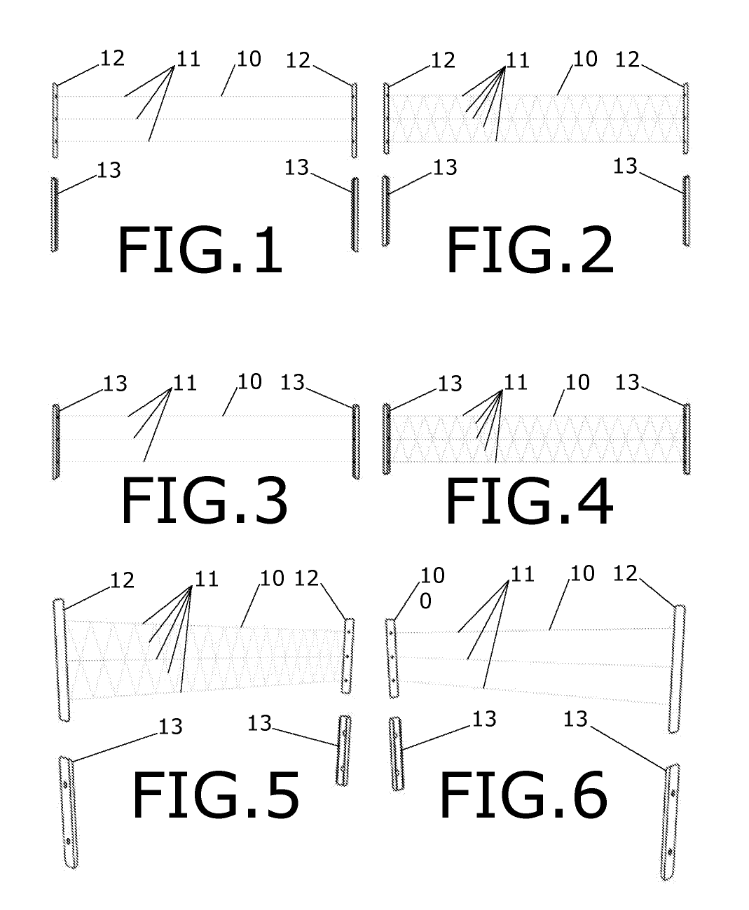

### DETAILED DESCRIPTION OF THE INVENTION

Referring now to the invention in more detail, the invention is a protective barrier 10 for an open window.

The first exemplary embodiment is comprised of a barrier 10, which is comprised of a plurality of thin, flexible filaments 11 drawn taut between two posts 12, which are secured to the window frame by brackets 13. The brackets 13 may be secured to the window frame by a pair of screws or similar fasteners. To install or remove the barrier 10, the posts 12 slide into and out of the brackets 13 vertically.

The filaments 11 may be comprised of monofilament fishing line or some other strong, flexible material that is corrosion resistant. The barrier 10 is designed for interior and exterior use on a window sill. The purpose of the barrier 10 is to protect objects placed on the window sill from being knocked off by a gust of wind, or by a passing person or animal. The barrier 10 may be used on an open or closed window. Alternate embodiments, wherein the design is modified for use on some other aperture such as a doorway or pass-through, are contemplated.

The second exemplary embodiment is similar in structure and function to the first exemplary embodiment, with the following modifications. Additional filaments 11 are provided in a diagonal crisscross pattern to protect smaller objects.

To use the first or the second exemplary embodiment, the user simply installs the brackets 13 on the window frame close to the sill, then inserts the posts 12 vertically into the brackets 13 and slides the posts 12 downward.

The filaments 11 are preferably manufactured from a flexible, durable material which are corrosion resistant, such as monofilament fishing line. The posts 12 and the brackets 13 are preferably manufactured from rigid, durable materials, such as hardwood, steel, aluminum alloy, or plastic.

Components, component sizes, and materials listed above are preferable, but artisans will recognize that alternate components and materials could be selected without altering the scope of the invention.

While the foregoing written description of the invention enables one of ordinary skill to make and use what is presently considered to be the best mode thereof, those of ordinary skill in the art will understand and appreciate the existence of variations, combinations, and equivalents of the specific embodiment, method, and examples herein. The invention should, therefore, not be limited by the above described embodiment, method, and examples, but by all embodiments and methods within the scope and spirit of the invention.

I claim:

1. A protective barrier for an open window, comprised of a barrier, which is comprised of a plurality of thin, flexible filaments drawn taut between two posts, which are secured to the window frame by brackets which may be secured to the window frame by a pair of screws or similar fasteners.

2. The barrier of claim 1, wherein the barrier may be installed or removed by sliding the posts vertically into and out of the brackets 13.

3. The barrier of claim 1, wherein the filaments may be comprised of strong, flexible material that is corrosion resistant, such as monofilament fishing line.

4. The barrier of claim 1, wherein additional filaments are provided in a diagonal crisscross pattern to protect smaller objects.

5. The barrier of claim 1, wherein the purpose of the barrier is to protect objects placed on the window sill from being knocked off by a gust of wind, or by a passing person or animal.

6. The barrier of claim 1, wherein the posts and the brackets are preferably manufactured from rigid, durable materials, such as hardwood, steel, aluminum alloy, or plastic.
